(19) United States
(12) Patent Application Publication
(10) Pub. No.: US 2010/0019628 A1
(43) Pub. Date: Jan. 28, 2010

(54) HIGH PERFORMANCE ROTATING RECTIFIER FOR AC GENERATOR EXCITERS AND RELATED METHODS

(75) Inventors: Jon Kitzmiller, Austin, TX (US); Michael C. Lewis, Austin, TX (US); Michael D. Werst, Manor, TX (US)

Correspondence Address: Jeffrey S. Whittle;BRACEWELL & GIULIANI LLP, P.O. Box 61389, Houston, TX, 77208-1389, US

(73) Assignee: The Board of Regents, The University of Texas System

(21) Appl. No.: 11/762,705

(22) Filed: Jun. 13, 2007

Related U.S. Application Data
(60) Provisional application No. 60/813,735, filed on Jun. 14, 2006.

(51) Int. Cl. H02K 11/04

(52) U.S. Cl. 310/68 D

(57) ABSTRACT

A brushless exciter apparatus including a rotatable rectifier hub assembly and associated methods are provided. The brushless exciter apparatus includes an exciter rotor assembly including a rotor core, a rotatable shaft carrying the rotor core, and an exciter armature having end turns extending beyond either side of an axial extent of the rotor core. The brushless exciter apparatus also includes a rotatable rectifier hub assembly including a rotatable rectifier hub carrying one or more diode assemblies positioned along an axial extent of the rotatable rotor shaft adjacent a rotor core, at least partially radially between an extent of the exciter armature and the outer surface of the shaft.

### GOVERNMENT LICENSE RIGHTS

This invention was made with government support under contract no. N068335-00-C-0189 SC B000702 awarded by the United States Navy/General Atomics Division. The government has certain rights in the invention.

### BACKGROUND OF THE INVENTION

1. Related Applications

This non-provisional application claims priority to and the benefit of U.S. Patent Application No. 60/813,735, filed on Jun. 14, 2006, incorporated herein by reference in its entirety.

2. Field of the Invention

The present invention relates to the design and manufacture of an in-situ serviceable high performance rotatable rectifier used in brushless exciters of AC generators.

3. Description of Related Art

Conventional electrical machines, such as AC generators, require a rotating DC field to energize its stationery armature windings. This rotating DC field is obtained from a separate source called an exciter. There are two types of exciters: static and rotating. Static exciters come in the form of circuits providing DC voltage from storage batteries or DC voltage from solid-state components including transformers, rectifiers, and reactors, etc. Rotating exciters come in the form of a rotating generator assembly, which generates a DC voltage used to power a rotating winding (form a rotating DC generator field) within the AC generator. Rotating exciters come in various configurations including those that require brushes to transfer the DC exciting current to the rotating DC generator field, those that require a combination of brushes and a commutator, and those that require no brushes, known as “brushless” exciters. Both brush type exciters and brushless type exciters can be mounted on the same rotatable shaft as that for the AC generator or can be mounted on a separate shaft. The main difference between brushless type exciters and brush type exciters is that in the brushless type exciters, the rotating slip rings of the brush type exciters are replaced with a rotatable (rotating) rectifier assembly.

A rotatable rectifier exciter is an example of a brushless exciter. The rotatable rectifier exciter uses, for example, a three-phase solid-state rotatable rectifier assembly mounted on a rotatable rectifier hub or wheel, which is electrically connected between the rotatable exciter armature and the rotating DC field winding of the AC generator. The rotatable rectifier hub or wheel is typically mounted on a common rotatable shaft, along with the exciter armature and rotatable rotor assembly. As such, the rotatable rectifier hub or wheel rotates with the exciter armature and rotatable rotor assembly. Conventionally, however, the rotatable rectifier hub and the rectifier assembly are both physically and electrically insulated from the exciter rotor and the exciter armature. Recognized by the Applicants, however, is that this physical separation, in particular, results in the exciter assembly being much larger and heavier, and therefore more expensive, than necessary. Also recognized by the Applicants is that the rotatable rectifier hub or wheel can be positioned underneath the exciter armature end turns to conserve space and minimize bearing span or overhang mass to thereby minimize detrimental rotor dynamic issues from operating at high shaft speeds. Further, recognized by the Applicants is the applicability of such configuration to both generators and motors that utilize a rotatable rectifier assembly.

In a typical AC generator using a brushless exciter, the AC output voltage of the AC generator is controlled by controlling the strength of the rotating DC field. Increasing the strength of the DC field increases the AC output voltage. Similarly, decreasing the strength of the DC field decreases the AC output voltage. A voltage regulator control is typically used to control the exciter stationery field, which, in turn, affects the strength of the rotating DC field to thereby provide a stable AC generator output, which matches the load on the AC generator. Thus, in operation, when the rotatable shaft is rotated, an AC voltage is induced in the exciter armature winding, which is then rectified by the rotatable rectifier assembly to provide DC current to the rotating DC field winding of the AC generator. Depending upon the load on the AC generator, the voltage regulator increases or decreases voltage to the exciter stationery field windings to thereby increase or decrease the output of the exciter to correspondingly increase or decrease the strength of the rotating DC field. This operation functions continuously as the load on the AC generator increases or decreases, to provide a stable, well-controlled, AC generator output voltage. Note, in very large generators, a pilot exciter may be used in order to initiate such AC power generation.

In order to rectify the power generated by the exciter armature winding, the rotatable rectifier assembly utilizes a series of diodes, typically at least two per phase in a polyphase system, to provide the rotating DC field. In low speed machines having low speeds and low power densities, conventional pig tail-type diodes carried on a rectifier wheel are adequate. As the shaft speed increases, i.e., at high rotational speeds, centrifugal and centripetal forces result in stress, vibration and balancing issues. The industry has tried to compensate by using, for example, silicon wafer diodes such as those typified by type A390P diodes, manufactured, for example, by General Electric Co. These diodes, however, require a relatively precise contact force between metallic contacts positioned against two spaced apart contact electrodes positioned along the functional axis of the diodes. One methodology of positioning these diodes is to position them within the rotatable shaft of the generator or motor along the axis of rotation to minimize, if not completely negate, the effects of the centrifugal and centripetal forces generated by high-speed rotation of the associated rotatable shaft.

Another more generally accepted methodology has been to fasten the diodes to a rotatable rectifier hub or wheel oriented so that the diode axis is perpendicular to the axis of rotation of the rotatable shaft. Such orientation has been necessitated conventionally because industry has believed that a parallel orientation for silicon wafer-type diodes positioned off the main axis of rotation outside the rotatable shaft would result in unacceptable variations in contact force between diode contacts in high-speed (high spin) electrical machines. Recognized by Applicants, however, is that such orientation results in the rotatable rectifier hub or wheel being much larger and heavier, and therefore more expensive, than necessary. Also recognized by Applicants is that silicon wafer diodes can be oriented parallel to the axis of rotation of the shaft if secured by resin or other bonding material capable of immobilizing the diodes to prevent centripetal force induced damage or degradation. Further, recognized by the Applicants is the need for an enhanced cooling system for the silicon wafer diodes if they are to be embedded in such material.

### SUMMARY OF THE INVENTION

In view of the foregoing, embodiments of the present invention provide a brushless exciter apparatus including a rotatable rectifier hub assembly and methods of forming the brushless exciter, specifically designed for use in high performance and high speed electrical machines applications. An embodiment of a full-wave rectifier of the present invention, for example, features a unique compact design that can be conveniently located integrally with the exciter of a high performance electrical machine. Advantageously, as a result of such design, the entire rectifier assembly can be replaced as an assembly as needed whenever any of the diodes fail. The design also advantageously can accommodate large diameter devices for advanced high performance pulsed generator designs.

More specifically, embodiments of the present invention provide an alternating current generator brushless exciter apparatus. For example, a brushless exciter apparatus according to an embodiment of the present invention can include a rotatable shaft having a shaft axis of rotation, a stator, and an exciter rotor assembly positioned along an axial extent of the shaft and rotating within the stator. The exciter rotor assembly can include, for example, a rotor core formed of, for example, a plurality of laminations defining an rotor stack clamped between a pair of end plates, and an exciter armature having end turns extending beyond either side of an axial extent of the rotor core. The rotor core can also include an internal clamping tube positioned to axially clamp the rotor stack between the pair of end plates. The exciter apparatus can also include a rotatable rectifier hub assembly including a rotatable rectifier hub carrying at least one pair of diodes for rectifying AC power and positioned along an axial extent of the shaft adjacent the rotor core, with at least portions positioned radially between an extent of the exciter armature and outer surface portions of the shaft. Advantageously, in this embodiment of the apparatus, the end plates of the rotor core can include an axial extension which supports the exciter armature and functions to separate the exciter rotor armature winding from the rotatable rectifier hub.

Embodiments of the present invention also provide a rotatable rectifier hub assembly adapted to be positioned along an axial extent of a rotatable shaft of an electrical machine. For example, a rotatable rectifier hub assembly according to an embodiment of the present invention can include a hub body, and at least one diode assembly carried by the hub body. The at least one diode assembly includes at least one pair of diodes for rectifying AC power that are oriented substantially parallel to the axis of rotation of the shaft. The hub body includes an annular recess extending axially inward and forming an annular cavity for receiving the at least one diode assembly. The annular cavity is subdivided to form a diode resin casted cavity section. Correspondingly, according to this embodiment of the rotatable rectifier hub assembly, the at least one diode assembly is positioned in the diode resin casted cavity section of the annular cavity. An AC bus ring and a pair of DC bus rings are also positioned within the annular cavity and extend through the at least one diode assembly. The diode resin casted cavity section is substantially filled with resin or other material to immobilize the diodes to thereby enhance control of the diode clamping force. Advantageously, such configuration can prevent centripetal force induced damage to the at least one pair of diodes during high speed rotation. Cooling is provided by the a plurality of cooling blades positioned circulate air over the AC and DC bus rings which thermally conduct heat from the diodes from within the resin casted cavity section or sections.

Embodiments of the present invention further provide methods of forming an alternating current generator brushless exciter and methods of forming a rotatable rectifier hub assembly adapted to be positioned along an axial extent of a rotatable shaft. For example, a method of forming an alternating current generator brushless exciter can include the steps of positioning an exciter rotor assembly including a rotor core and an exciter armature along an axial extent of a rotatable shaft, positioning at least one diode assembly (including a pair of diodes for rectifying AC power) within a rotatable rectifier hub assembly, and positioning the rotatable rectifier hub assembly along an axial extent of the rotatable shaft adjacent the rotor core with at least portions of the rotatable rectifier hub assembly radially between an extent of the exciter armature, e.g., end turns, and the rotatable shaft. The exciter armature can have end turns extending beyond either side of an axial extent of the rotor core. The rotor core can include a plurality of laminations defining a rotor stack clamped between a pair of end plates.

Synergistically, a method of forming a rotatable rectifier hub assembly adapted to be positioned along an actual extent of a rotatable shaft can include the step of positioning at least one, but preferably three, diode assemblies each including at least one pair of diodes for rectifying AC power within a hub body of a rotatable rectifier hub assembly, so that each of the diodes are oriented substantially parallel to the axis of rotation of the shaft when the rotatable rectifier hub assembly is positioned along the axial extent of the rotatable shaft. Specifically, the method can also include the step of subdividing an annular cavity of the hub body to form at least one, but also preferably three, diode resin casted cavity sections, positioning the respective diode assemblies separately in each of the diode resin casted cavity sections, and substantially filling the diode resin casted cavity sections with resin or other bonding material to immobilize the diodes to thereby enhance control of diode clamping force, preventing centripetal force induced damage to the respective diodes of each of the diode assemblies during high speed rotation.

In general, embodiments of the present invention provide an attractive upgrade to existing older rectifier designs in use today. Specifically, embodiments of the present invention are desirable for high power pulsed generator applications where very high power and responsive excitation currents are required for the generator. The rotatable rectifier bridge of the rotatable exciter, for example, is modular in design, simplifying service procedures and cost. Accordingly, such design can accommodate large diameter rectifier devices and operate at very high speeds.

### BRIEF DESCRIPTION OF THE DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a perspective partially cut away view of a rotor and a small portion of a stator of an alternating current (AC) generator exciter apparatus according to an embodiment of the present invention;

FIG. 2 is a perspective partially cut away view of an rotatable rectifier hub assembly adjacent an exciter rotor assembly according to an embodiment of the present invention;

FIG. 3 is a perspective cut away view of a hub body of a rotatable rectifier hub assembly according to an embodiment of the present invention;

FIG. 4 is a perspective cut away view of a diode assembly positioned in a diode resin casted cavity within a hub body of a rotatable rectifier hub assembly according to an embodiment of the present invention;

FIG. 5 is a perspective view of a hub body of a rotatable rectifier hub assembly according to an embodiment of the present invention;

FIG. 6 is a perspective interior view of the diode assembly of FIG. 4 prior to being positioned within a hub body of a rotatable rectifier hub assembly according to an embodiment of the present invention;

FIG. 7 is a perspective exterior view of the diode assembly of FIG. 4 prior to being positioned within a hub body of a rotatable rectifier hub assembly according to an embodiment of the present invention;

FIG. 8 is a perspective view of a rotatable rectifier hub assembly according to an embodiment of the present invention;

FIG. 9 is a perspective view of a portion of a rotatable rectifier hub assembly according to an embodiment of the present invention;

FIG. 10 is a perspective view of a conventional brushless exciter apparatus;

FIG. 11 is a schematic flow diagram illustrating a method of forming a brushless exciter apparatus according to an embodiment of the present invention; and

FIG. 12 is a schematic flow diagram illustrating a method of forming a rotatable rectifier hub assembly according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. Prime notation, if used, indicates similar elements in alternative embodiments.

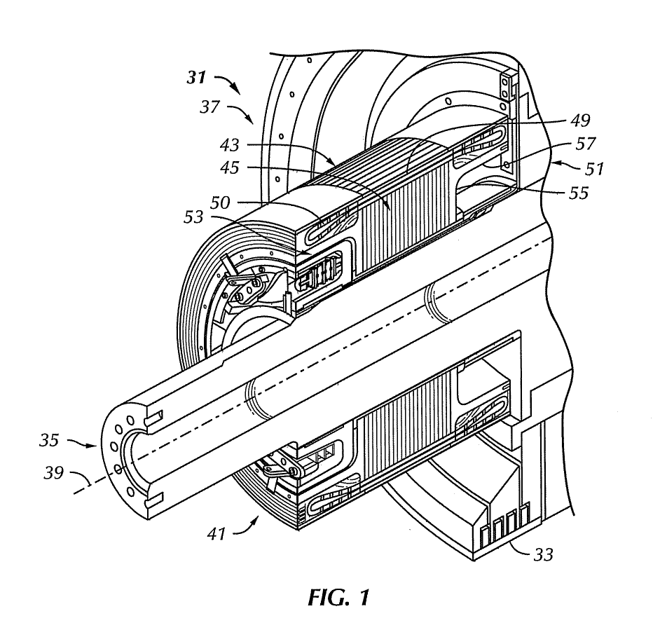

FIGS. 1-9 and 11-12 illustrate a brushless exciter apparatus 31 for a high-speed electric machine, a rotatable rectifier hub assembly 41, methods of forming a brushless exciter apparatus 31, and methods of forming a rotatable rectifier hub assembly 41, according to embodiments of the present invention. In general, embodiments of a brushless exciter apparatus 31 include a stator 33, a rotatable shaft 35, an exciter rotor assembly 37 rotationally positioned within the stator 33 and positioned on and rotated by the shaft 35, and a rotatable rectifier hub assembly 41 positioned adjacent the exciter rotor assembly 37 and the stator 33.

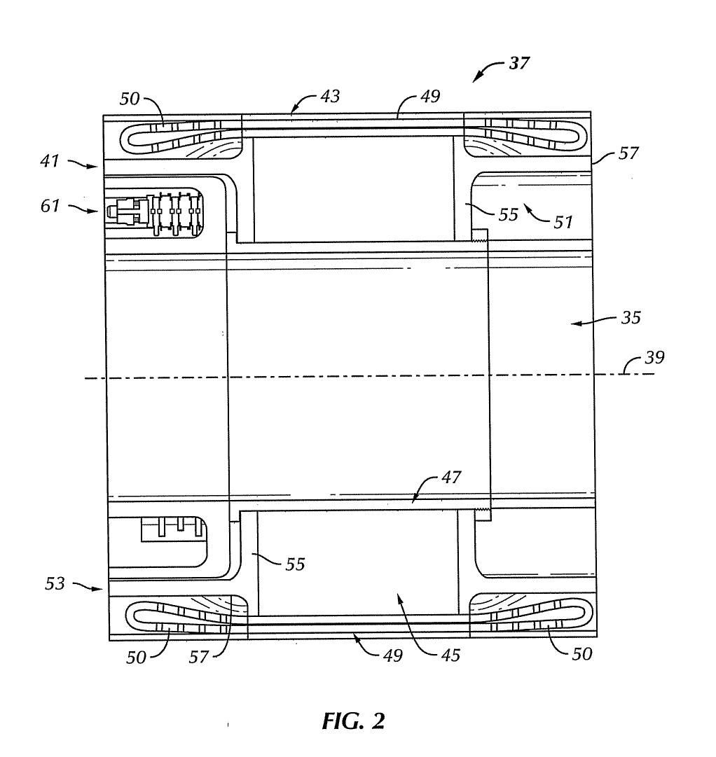

FIGS. 1-9 illustrate examples of the brushless exciter apparatus 31 and rotatable rectifier hub assembly 41, according to embodiments of the present invention, are particularly configured for high-speed electric machine applications. FIG. 1 particularly illustrates an alternating current exciter apparatus 31 of an embodiment of the present invention including an exciter rotor assembly 37 including a rotatable shaft 35 having a shaft axis of rotation 39, and a rotor core 43 positioned on and rotated by the shaft 35 within the confines of a stator 33 (almost completely cut away in the figure) associated with the exciter rotor assembly 37. The rotor core 43, according to a preferred configuration, can include a plurality of laminations defining a rotor stack 45 clamped between a pair of end plates 51, 53. Note, the rotor core 43 can be conventional or can be according to a unique clamping design utilizing a uniquely configured clamping tube 47 such as that perhaps best shown in FIG. 2, and disclosed in more detail in copending U.S. patent application Ser. No. ______by Werst et al. titled “Rotor Assembly and Method of Assembling a Rotor of a High Speed Electric Machine”, filed Jun. 13, 2007.

The rotor core 43 of the exciter rotor assembly 37 can also include an exciter armature 49 having end turns 50 extending beyond either side of an axial extent of the rotor stack 45. Accordingly, as perhaps best shown in FIGS. 1 and 2, one or more of the pair of end plates 51, 53, can have a shape, such as, for example, a Belleville shape as understood by those skilled in the art. These end clamp plates 51, 53, can include both an end plate radial portion 55 and an end plate axial extension portion 57. The end plate radial portion 55 is generally positioned substantially perpendicular to the shaft axis of rotation 39 and in contact with the rotor stack 45, to impart a sufficient stiffness profile, for example, to maintain a substantially uniform preload on the rotor stack 45. The end plate axial extension portion 57 can extend substantially perpendicular to the end plate radial portion 55, and substantially parallel to the shaft axis of rotation 39, to support inner surface portions of, for example, the end turns 50 of the an exciter armature 49 of the exciter rotor assembly 37, when used, for example, in an electrical machine, such as a generator, having such armature 49. Beneficially, such axial extension or extensions 57 allow for compacting various components under the armature 49, particularly the end turns 50.

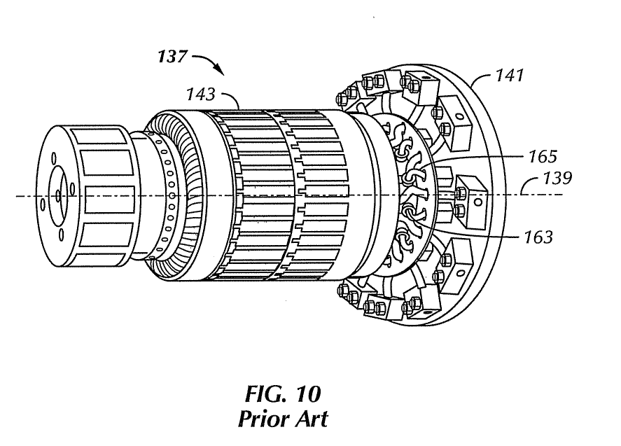

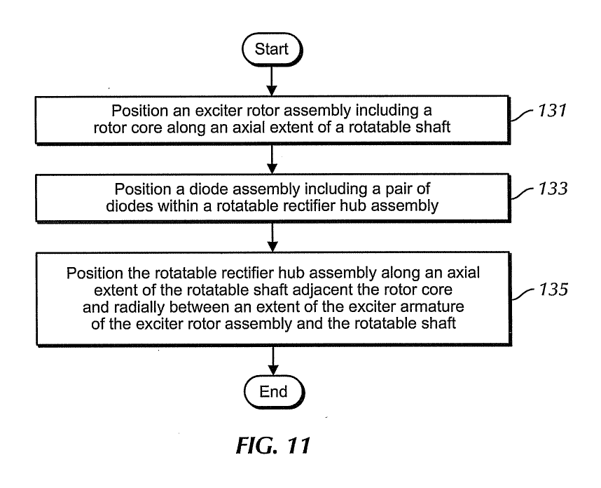

Accordingly, the rotatable rectifier assembly 41 of the exciter apparatus 31 can be axially positioned along an axial extent of the shaft 35 adjacent the rotor core 43, and can be, in certain embodiments, substantially radially positioned under the confines of the end turns 50 of the armature 49. That is, the rotatable rectifier hub assembly 41 can be radially positioned between inner surface portions of the end plate axial extension portion 57 of the end plate 53 and outer surface portions of the shaft 35 radially adjacent the end plate axial extension 57 of the end plate 53, in certain embodiments. Note, FIG. 10 illustrates conventional implementation of a brushless exciter rotor assembly 137 including a conventional implementation of a rectifier bridge hub assembly 141. Notably, the rectifier bridge hub assembly 141 has a much larger radius than the radius of its rotor core 143 of its exciter rotor assembly 137 and is physically spaced apart from the rotor core 143 of its exciter rotor assembly 137.

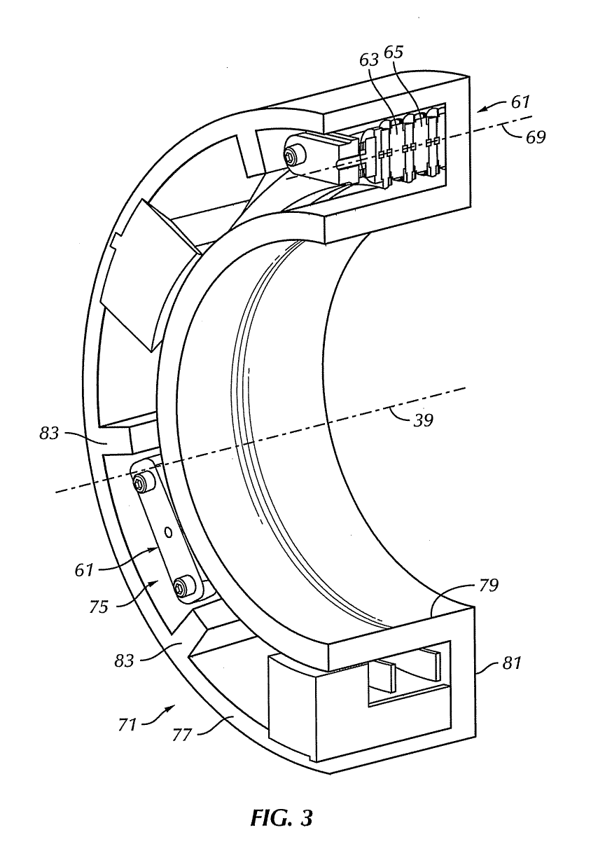

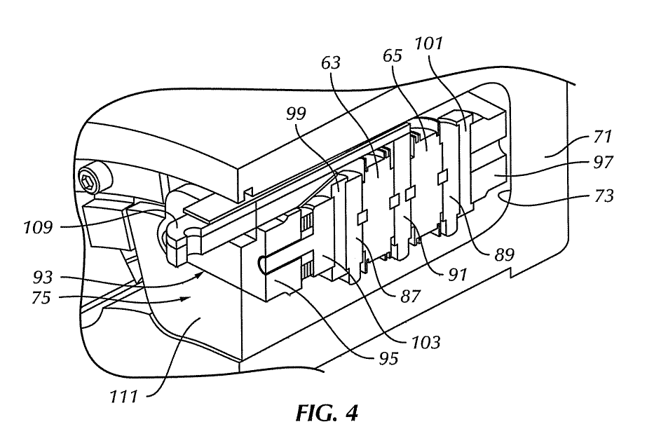

As perhaps best illustrated in FIGS. 3 and 4, the rotatable rectifier hub assembly 41 can carry at least one, but typically three, diode assemblies 61, e.g., three assemblies for a three-phase AC generator spaced 120 degrees apart, with each of the diode assemblies 61 including at least one pair of diodes 63, 65, for rectifying AC power. In the illustrated embodiments, each pair of diodes 63, 65, are cylindrically shaped silicon wafer diodes 63, 65, oriented so that the main axis 69 of each diode 63, 65, is oriented substantially parallel to the shaft axis of rotation 39. Note, FIG. 10 illustrates conventional off-axis positioning of silicon wafer diodes 163, 165. Specifically, the silicon wafer diodes 163, 165, are oriented so their main axes are perpendicular to the shaft axis of rotation 139. The diode assemblies 61 will be described in more detail later.

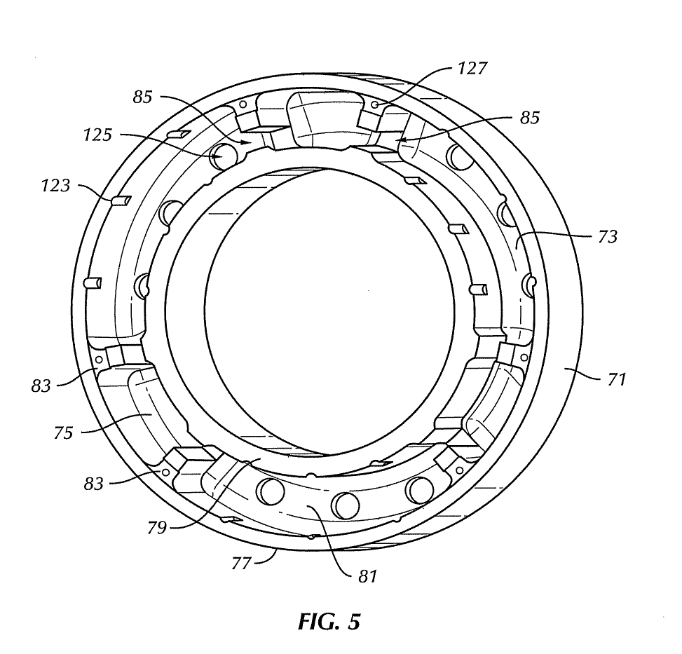

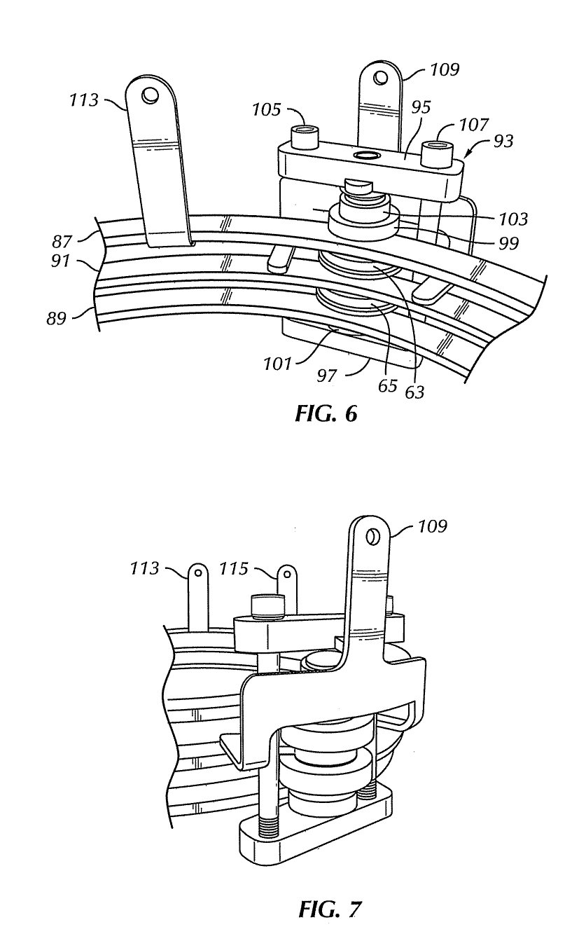

As perhaps best shown in FIGS. 3, 4, and 5, the rotatable rectifier hub assembly 41 includes a hub body 71 having an annular recess extending axially in the direction of the rotor stack 45 of the rotor core 43 of the exciter rotor assembly 37 to form an annular cavity 73 for receiving the diode assembly or assemblies 61. As perhaps best shown in FIG. 5, the annular cavity 73 is subdivided to form, e.g., three diode resin casted cavity sections 75. Each diode resin casted cavity section 75 is bounded by an axially extending outer radial wall 77 of the hub body 71, an axially extending inner radial wall 79, and a radially extending rotor side wall 81, extending between the outer radial wall 77 and the inner radial wall 79. The diode resin casted cavity sections 75 are each further at least partially radially bound by two axially extending inwardly directed protuberances 83 extending radially inwardly from the outer radial wall 77. In the illustrated embodiment, the protuberances 83 fall short of extending completely between the outer radial wall 77 and the inner radial wall 79 to provide a slot 85 to accommodate one or more annular shaped DC bus rings 87, 89 (see, e.g., FIG. 6), and/or an at least partially annular shaped AC bus ring/bar 91, described in more detail later. Note, according to an embodiment of the hub body 71, walls 77 and 79 have a one degree taper.

As perhaps best shown in FIGS. 3 and 4, each diode assembly 61 is separately positioned in one of the cavity sections 75. As noted above, the AC bus ring 91 and two DC bus rings 87, 89, are stacked axially within slot 85 of the annular cavity 73 of the hub body 71. Each ring 87, 89, 91, can be either complete rings or can have intermittent gaps, depending upon the position of the associated power transmission conductors. Regardless, each ring 87, 89, 91, has portions that extend through the respective diode resin casted cavity section 75 of each diode assembly 61, and through certain components of each respective diode assembly 61. Particularly, at least portions of the AC bus ring 91 extend physically between diodes 63 and 65 of each pair of diodes 63, 65, and is positioned in electrical contact with the cathode of one of the diodes 63, 65, and the anode of the other one of the diodes 63, 65 of each of the at least one pair of diodes. Whether the AC bus ring 91 contacts the anode of diode 63/cathode of diode 65 or the cathode of diodes 63/anode of diodes 65 depends upon whether the cathodes of the diodes 63, 65, face side wall 81, or vice versa. Accordingly, if the diodes 63, 65 are axially oriented with the cathodes facing side wall 81, the AC bus ring 91 will be in electrical contact the cathode of diode 63 and the anode of diode 65.

Similarly, one of the DC bus rings 87, 89, is positioned physically opposite the AC bus ring 91 and in electrical contact with the anode of one of the diodes 63, 65, with the other also physically opposite the AC bus ring 91 and in contact with the cathode of the other one of the diodes 63, 65. Above exemplary configuration, if the diodes 63, 65, are axially oriented with the cathodes facing side wall 81, DC bus ring 87 is in electrical contact with the anode of diode 63 and DC bus ring 89 is in electrical contact with the cathode of diode 65. This configuration arrangement similarly applies to other diode assemblies 61, if installed.

As noted previously, wafer diodes have very sensitive clamping requirements. In order to support the diodes 63, 65, and other rectifier elements in high-speed environments, especially when oriented parallel to the shaft axis of rotation 39, they can be first clamped to/between the bus bars/rings 87, 89, 91. Accordingly, as perhaps best shown in FIG. 4, embodiments of the diode assembly 61 include a clamp plate assembly 93 having a pair of clamp plate jaws 95, 97, positioned to fixedly clamp the diodes 63, 65. Accordingly, diodes 63, 65, the portion of the AC bus ring 91 extending between the diodes 63, 65, and the portions of each pair of DC bus rings 87, 89, extending through the respective diode assembly 61, are clamped axially together between the pair of clamp plate jaws 95, 97, at a preselected clamping force, e.g., 2200 lbf. A pair of insulating pucks 99, 101, are provided to insulate the clamping jaws 95, 97, from the respective pairs of DC buses 87, 89. Further, according to the exemplary embodiment of the diode assembly 61, a thrust plate 103 is provided to interface with the DC buses 87, 89, to enhance application of axially directed compression between the jaws 95, 97. A pair of fasteners 105, 107, extend between jaws 95, 97, and allow for ready adjustment/selection of the desired clamping force.

As perhaps best shown in FIG. 4, each diode assembly includes an AC jumper assembly 109 positioned to provide AC power to the pair of diodes 63, 65, and to sink heat generated by the diodes 63, 65, as will be described in more detail below. Similarly, as perhaps best shown in FIGS. 6 and 7, each DC bus includes a DC bus jumper 113, 115, respectively, which provide a portion of a conduit to deliver power from the rotatable rectifier hub assembly 41 and to the rotating DC field of the AC generator.

In order to support the diodes 63, 65, and the other components of the diode assemblies 61 in high-speed environments, especially when the diodes 63, 65, are oriented parallel to the shaft axis of rotation 39, the diode resin casted cavity section 75 can be substantially filled with resin 111, or other bonding material known to those skilled in the art, to immobilize the components of the diode assembly 61, to thereby enhance control of diode clamping force and to thereby prevent centripetal force induced damage or degradation to the diodes 63, 65, during high speed rotation. As described previously, wafer diodes are extremely sensitive to clamping force variations. By positioning the diodes 63, 65, parallel to the axis of rotation, axial clamping force can be precisely controlled. This, however, assumes that the radial forces generated by rotation of the shaft 35 do not interfere with the integrity of the “stack” of clamped diode accessory components, described above. In order to maintain the integrity of the “stack,” the bonding material, e.g., resin 111, is positioned within the resin casted cavity section 75 to immobilize the diodes 63, 65, thereby mitigating the large centripetal forces that would otherwise negatively impact the relatively sensitive clamping requirements.

The application of bonding material, e.g., resin 111, however, would otherwise tend to disrupt cooling the diodes 63, 65. Accordingly, as described above, embodiments of the rotatable rectifier hub assembly 41 have annular shaped DC bus rings 87, 89 (see, e.g., FIG. 6), and an at least partially annular shaped AC bus ring/bar 91 extending through the diode assembly or assemblies 61, in physical contact with the diodes 63, 65, to not only conduct electricity, but to sink heat generated by the diodes 63, 65. That is, the diodes 63, 65, are cooled through thermal conduction of heat outside the resin casted cavity section 75 through physical contact with the buses 87, 89, and 91, and with AC jumper 109.

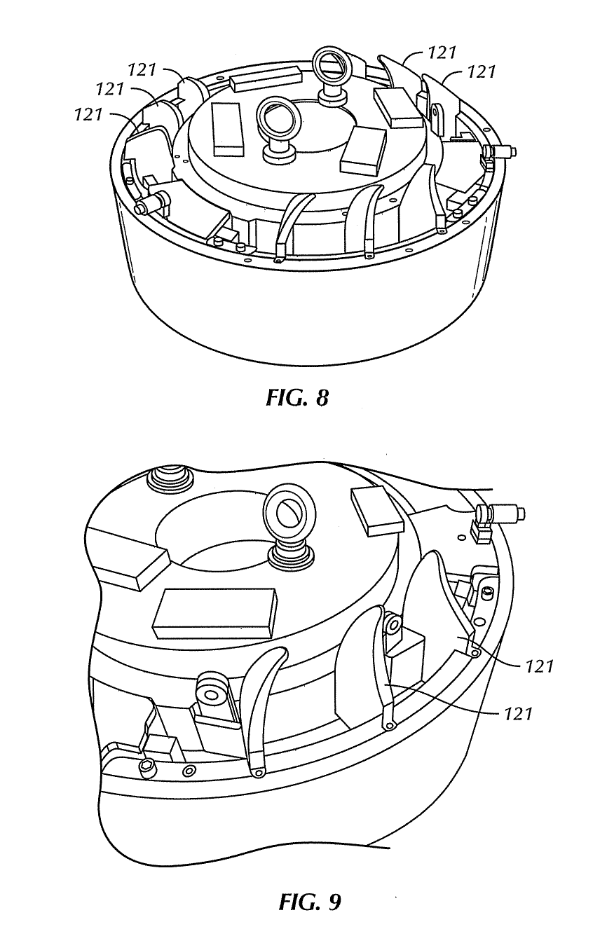

Still further, and as perhaps best shown in FIGS. 8 and 9, embodiments of the rotatable rectifier of assembly 41 include a plurality of airfoils, e.g., cooling blades 121, positioned along the circumference of the hub of body 71 to enhance the thermal conduction via the buses 87, 89, 91, by directing airflow over the buses 87, 89, 91. According to a preferred configuration, the cooling blades 121 are connected to side wall 77 of the hub body 71 (FIG. 5) via a corresponding number of airfoils slots 123 configured to receive the cooling blades 121. The rotor side wall 81 of the hub body 71 includes a corresponding number of apertures, e.g., airflow exit holes 125, to enhance the flow of air over the buses 87, 89, 91. In operation, as the hub body 71 is rotated, the cooling blades 121 gather and direct air over the buses 87, 89, 91, and through airflow exit holes 125, which circulates back over the outside of the hub body 71 between an outer surface of side wall 77 and inner surfaces of end plate 53. Beneficially, such rotatable rectifier hub assembly design allows for implementation of a three phase bridge (three diode assembly 61 each having at least two diodes 63, 65) capable of providing a power density in excess of 180 MW/m³.

Embodiments of the present invention also provide methods of forming an alternating current generator brushless exciter 31 and methods of forming a rotatable rectifier hub assembly 41 adapted to be positioned along an axial extent of a rotatable shaft 35. For example, as shown in FIG. 11, a method of forming an alternating current generator brushless exciter 31 can include the steps of positioning an exciter rotor assembly 37 including a rotor core 43 and an exciter armature 49 along an axial extent of a rotatable shaft 35 (block 131), positioning at least one diode assembly 61 including a pair of diodes 63, 65, for rectifying AC power within a rotatable rectifier hub assembly 41 (block 133), and positioning the rotatable rectifier hub assembly 41 along an axial extent of the rotatable shaft 35 adjacent the rotor core 43 with at least portions of the rotatable rectifier hub assembly 41 radially between an extent of the exciter armature 49, e.g., end turns 50, and the rotatable shaft 35 (block 135). As perhaps best shown in FIG. 2, the exciter armature 49 can include end turns 50 which extend beyond either side of an axial extent of the rotor core 43. The rotor core 43 can include a plurality of laminations defining a rotor stack 45 clamped between a pair of end plates 51, 53. Other configurations are, nevertheless, within the scope of the present invention.

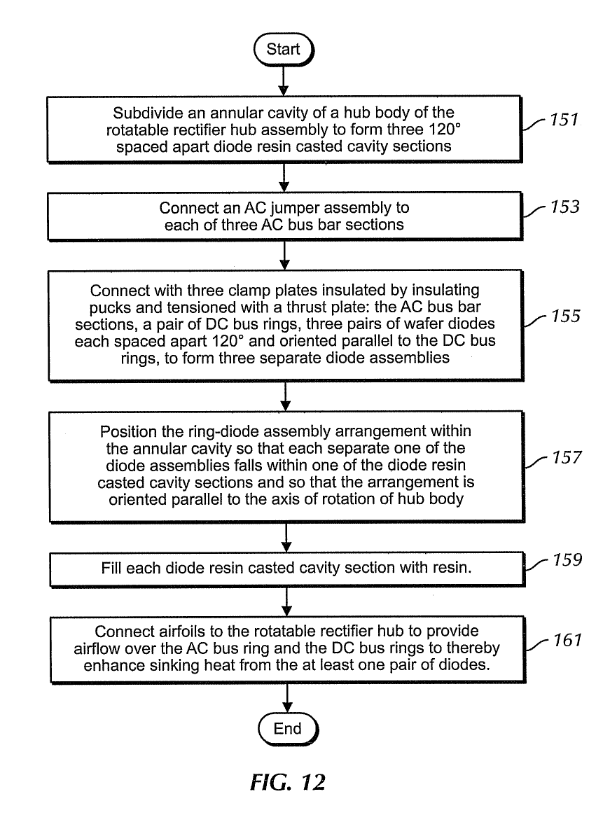

As shown in FIG. 12, a method of forming a rotatable rectifier hub assembly 41 adapted to be positioned along an axial extent of a rotatable shaft 35 having a shaft axis of rotation 39, is illustrated. The method can include the step of subdividing an annular cavity 73 of the hub body 71 (block 151) to form at least one, but also preferably three, diode resin casted cavity sections 75, spaced 120° apart. The method can also include the steps of connecting an AC jumper assembly 109 to each of the three associated sections of the AC bus bar/ring 91 at 120° intervals (block 153), connecting sections of the AC bus bar/ring 91, a pair of DC bus rings 87, 89, and three pairs of wafer diodes 63, 65, oriented parallel to the DC bus rings 87, 89, with three clamp plates 93 insulated by insulating pucks 99, 101, and tensioned with a thrust plate 103 (block 155), to form three separate diode assemblies 61 spaced 120° apart. Note, as described previously, the AC jumper assembly 109 and the AC bus bar/ring 91 provides AC power to the diodes, the DC buses 87, 89, and DC jumpers 113, 115, receive DC power, and each, to some extent sink (conduct) heat generated by the diodes 63, 65, of the respective diode assemblies 61.

The method also includes the step of positioning this ring-diode assembly arrangement (FIG. 6) within the annular cavity 73 (block 157) so that each separate one of the diode assemblies 61 falls within one of the diode resin casted cavity sections 75, and so that the arrangement is oriented parallel to the axis of rotation 39 of the hub body 71/shaft 35 when the rotatable rectifier hub assembly 41 is positioned along the axial extent of the rotatable shaft 35. The method further includes the step of substantially filling the diode resin casted cavity sections 75 with resin or other bonding material 111 (block 159) immobilize the diode assemblies 61. As noted above, beneficially, such immobilization serves to enhance control of diode clamping force applied to the diodes 63, 65, to thereby prevent centripetal force induced damage to the respective diodes 63, 65, of each of the diode assemblies 61 during high speed rotation.

The method further includes connecting airfoils 121 to the rotatable rectifier hub 41 (block 161) to provide airflow over the AC bus ring 91 and the DC bus rings 87, 89 to thereby enhance sinking heat (thermal conduction) from the respective pair of diodes 63, 65, from each diode assembly 61.

The unique design and positioning of the rotatable rectifier hub assembly 41 provides several benefits. For example, this design addresses the special needs of extreme power density, continuous and pulse duty AC generators. The design allows for the formation of a three-phase rectifier bridge having a power density rating in excess of 180 MW/m³. The design is unique as compared to conventional designs that are too heavy and cumbersome to be useable in high speed applications. The design is simplistic yet robust as compared to conventional designs. The design is also compact enough to permit its installation inside the generator, beneath the end turns of the exciter rotor assembly, yet it can accommodate large diameter rectifier devices. This design can be used in AC generators including both conventional and modem high power density designs. It is uniquely adaptable to extreme condition pulsed duty AC generators. The design of the rotatable rectifier hub assembly 41 can also be implemented in motors requiring a rotating DC field.

This Application is related to U.S. Patent Application No. 60/813,735 by Kitzmiller et al. titled “High Performance Rotating Rectifier for AC Generator Exciters”, filed Jun. 14, 2006, U.S. patent application Ser. No. ______ by Werst et al. titled “Rotor Assembly and Method of Assembling a Rotor of a High Speed Electric Machine” filed Jun. 13, 2007, U.S. Patent Application No. 60/813,067, by Werst et al. titled “Apparatus and Method for Clamp ______ Laminations in a High Speed Electric Motors”, filed Jun. 13, 2006, PCT Patent Application No. by Lewis et al. titled “Fabrication of Heat-Treated Laminations for High-Speed Rotors in Electrical Machines” filed Jun. 13, 2007, U.S. Patent Application No. 60/813,680, by Lewis et al. titled “Fabrication of Heat-Treated Laminations for High-Speed Rotors in Electrical Machines, filed Jun. 14, 2006, and U.S. Patent Application No. 60/814,017, by Jordan et al. titled “Electric Machinery Laminated Cores With Insulating Laminations”, filed Jun. 15, 2006, each incorporated by reference in their entireties.

In the drawings and specification, there have been disclosed typical preferred embodiments of the invention and, although specific terms are employed, they are used in a generic and descriptive sense only and not for the purpose of limitation, the scope of the invention being set forth in the following claims. For example, although the exemplary embodiments focused primarily on AC generators, the rotatable rectifier hub assembly can also be implemented in other electrical machines requiring a rotating DC field. Also, although the exemplary embodiments described a laminate-type rotor core, other rotor core configurations are within the scope of the present invention.

That claimed is:

1. An alternating current generator brushless exciter apparatus, comprising:
a rotatable shaft having a shaft axis of rotation;
an exciter rotor assembly positioned along an axial extent of the shaft and including:
a plurality of laminations defining an rotor stack clamped between a pair of end plates, the rotor stack and the pair of end plates defining a rotor core, and
an exciter armature having end turns extending beyond either side of an axial extent of the rotor core; and
a rotatable rectifier hub assembly including a rotatable rectifier hub positioned along an axial extent of the shaft adjacent the rotor core, at least portions of the rotatable rectifier hub positioned radially between an extent of the exciter armature and outer surface portions of the shaft, the hub carrying at least one diode assembly including at least one pair of diodes for rectifying AC power.

2. An apparatus as defined in claim 1, wherein the at least one pair of diodes are a pair of silicon wafer diodes oriented substantially parallel to the shaft axis of rotation.

3. An apparatus as defined in claim 2, wherein the rotatable rectifier hub includes a hub body having an annular recess extending axially in a direction of the exciter rotor assembly and forming an annular cavity for receiving the at least one diode assembly.

4. An apparatus as defined in claim 3,
wherein the annular cavity is subdivided to form a diode resin casted cavity section; and
wherein the at least one diode assembly is positioned in the diode resin casted cavity section of the annular cavity, the diode resin casted cavity section substantially filled with resin to enhance control of diode clamping force to thereby prevent centripetal force induced damage or degradation to the at least one pair of diodes during high speed rotation.

5. An apparatus as defined in claim 4,
wherein the rotatable rectifier hub assembly further includes an AC bus ring and a pair of DC bus rings positioned within the annular cavity; and
wherein a portion of the AC bus ring and a portion of each pair of DC bus rings extend through the at least one diode assembly.

6. An apparatus as defined in claim 5,
wherein the AC bus ring is positioned between and in electrical contact with the cathode of a first one of the at least one pair of diodes and the anode of a second one of the at least one pair of diodes;
wherein one of the DC bus rings is positioned in electrical contact with the anode of the first one of the at least one pair of diodes and the other of the DC bus rings is positioned in electrical contact with the cathode of the second one of the at least one pair of diodes;
wherein the at least one diode assembly includes a clamp plate assembly having a pair of clamp plate jaws; and
wherein the first and the second ones of the at least one pair of diodes, the portion of the AC bus ring, and the portions of each pair of DC bus rings extending through the at least one diode assembly are clamped axially between the pair of clamp plate jaws at a preselected clamping force.

7. An apparatus as defined in claim 6, wherein the rotatable rectifier hub body includes a plurality of hub apertures positioned to provide axial airflow, and wherein the rotatable rectifier hub assembly includes a plurality of airfoils positioned to provide airflow over the AC bus ring, DC bus rings, and AC jumper assembly and through the plurality of hub apertures to thereby enhance sinking heat from the at least one pair of diodes.

8. An apparatus as defined in claim 7, wherein the at least one diode assembly includes an AC jumper assembly positioned to provide AC power to the at least one pair of diodes and to further sink heat generated by the at least one pair of diodes.

9. An apparatus as defined in claim 8, wherein the at least one diode assembly includes three diode assemblies radially spaced 120° apart, each of the diode assemblies having the at least one pair of diodes to thereby form a three-phase rotatable rectifier bridge.

10. An apparatus as defined in claim 9, wherein the rotatable rectifier bridge provides a power density of at least 180 MW/m³.

11. A rotatable rectifier hub assembly adapted to be positioned along an axial extent of a rotatable shaft of an electrical machine having a shaft axis of rotation, the rotatable rectifier hub comprising:
a hub body; and
at least one diode assembly carried by the hub body and including at least one pair of diodes for rectifying AC power, the at least one pair of diodes oriented substantially parallel to the axis of rotation of the shaft.

12. A hub assembly as defined in claim 11, wherein the hub body includes an annular recess extending axially inward and forming an annular cavity for receiving the at least one diode assembly.

13. A hub assembly as defined in claim 12,
wherein the annular cavity is subdivided to form a diode resin casted cavity section; and
wherein the at least one diode assembly is positioned in the diode resin casted cavity section of the annular cavity, the diode resin casted cavity section substantially filled with resin to enhance control of diode clamping force to thereby prevent centripetal force induced damage to the at least one pair of diodes during high speed rotation.

14. A hub assembly as defined in claim 12, further comprising an AC bus ring and a pair of DC bus rings positioned within the annular cavity, a portion of the AC bus ring and a portion of each pair of DC bus rings extending through the at least one diode assembly.

15. A hub assembly as defined in claim 14,
wherein the AC bus ring is positioned between and in electrical contact with the cathode of a first one of the at least one pair of diodes and the anode of a second one of the at least one pair of diodes;
wherein one of the DC bus rings is positioned in electrical contact with the anode of the first one of the at least one pair of diodes and the other of the DC bus rings is positioned in electrical contact with the cathode of the second one of the at least one pair of diodes;
wherein the at least one diode assembly includes a clamp plate assembly having a pair of clamp plate jaws; and
wherein the first and the second ones of the at least one pair of diodes, the portion of the AC bus ring, and the portions of each pair of DC bus rings extending through the at least one diode assembly are clamped axially between the pair of clamp plate jaws at a preselected clamping force.

16. A hub assembly as defined in claim 15, further comprising a plurality of airfoils positioned to provide airflow over the AC bus ring and the DC bus rings to thereby enhance sinking heat from the at least one pair of diodes.

17. A hub assembly as defined in claim 11, wherein the at least one diode assembly includes an AC jumper assembly positioned to provide AC power to the at least one pair of diodes and to sink heat generated by the at least one pair of diodes.

18. A hub assembly as defined in claim 11, wherein the at least one diode assembly includes three diode assemblies radially spaced 120° apart, each of the diode assemblies having the at least one pair of silicon wafer diodes to thereby form a three-phase rotatable rectifier bridge.

19. A hub assembly as defined in claim 18, wherein each of the three diode assemblies includes at least one pair of silicon wafer diodes, and wherein the rotatable rectifier bridge provides a power density of at least 180 MW/m³.

20. A method of forming an alternating current generator brushless exciter apparatus, comprising the steps of:
positioning an exciter rotor assembly along an axial extent of a rotatable shaft, the exciter rotor assembly including a rotor core comprising a plurality of laminations defining an rotor stack clamped between a pair of end plates, and an exciter armature having end turns extending beyond either side of an axial extent of the rotor core;
positioning at least one diode assembly within a rotatable rectifier hub assembly, the at least one diode assembly including at least one pair of diodes for rectifying AC power; and
positioning the rotatable rectifier hub assembly along an axial extent of the rotatable shaft adjacent the rotor core with at least portions of the rotatable rectifier hub assembly radially between an extent of the exciter armature and the rotatable shaft.

21. A method of forming a rotatable rectifier hub assembly adapted to be positioned along an axial extent of a rotatable shaft having a shaft axis of rotation, the method comprising the step of:
positioning at least one diode assembly within a hub body of a rotatable rectifier hub assembly, the at least one diode assembly including at least one pair of diodes for rectifying AC power, the at least one pair of diodes positioned so that each of the diodes are oriented substantially parallel to the axis of rotation of the shaft when the rotatable rectifier hub assembly is positioned along the axial extent of the rotatable shaft.

22. A method as defined in claim 21, wherein the hub body includes an annular recess extending axially inward and forming an annular cavity for receiving the at least one diode assembly.

23. A method as defined in claim 22, further comprising the steps of:
subdividing the annular cavity to form at least one a diode resin casted cavity section;
positioning the at least one diode assembly in the at least one diode resin casted cavity section of the annular cavity; and
substantially filling the at least one diode resin casted cavity section with resin to enhance control of diode clamping force applied to the at least one pair of diodes of the at least one diode assembly to thereby prevent centripetal force induced damage to the at least one pair of diodes during high speed rotation.

24. A method as defined in claim 23, further comprising the step of positioning an AC bus ring and a pair of DC bus rings within the annular cavity to extend radially through the at least one diode assembly.

25. A method as defined in claim 24,
positioning the AC bus ring between and in electrical contact with the cathode of a first one of the at least one pair of diodes and the anode of a second one of the at least one pair of diodes;
positioning one of the DC bus rings in electrical contact with the anode of the first one of the at least one pair of diodes and the other of the DC bus rings in electrical contact with their cathode of the second one of the at least one pair of diodes; and
clamping the first and the second ones of the at least one pair of diodes, the portion of the AC bus ring, and the portions of each pair of DC bus rings extending through the at least one diode assembly axially between a pair of clamp plates arms at a preselected clamping force.

26. A method as defined in claim 25, further comprising the step of connecting a plurality of airfoils to the hub body of the rotatable rectifier hub assembly to provide airflow over the AC bus ring and the DC bus rings to thereby enhance sinking heat from the at least one pair of diodes.

27. A method as defined in claim 25, further comprising the step of connecting an AC jumper assembly to the AC bus ring for the at least one diode assembly to provide AC power to the at least one pair of diodes and to sink heat generated by the at least one pair of diodes of the at least one diode assembly.

28. A method as defined in claim 27, wherein the at least one diode assembly includes three diode assemblies radially spaced 120° apart, each of the diode assemblies having the at least one pair of diodes to thereby form a three-phase rectifier bridge having a power density rating of at least 180 MW/m³.
